(19) United States
(12) Patent Application Publication
(10) Pub. No.: US 2022/0315758 A1
(43) Pub. Date: Oct. 6, 2022

(54) THERMOPLASTIC POLYMER BLENDS

(71) Applicant: Covestro LLC, Pittsburgh, PA (US)

(72) Inventors: Liang Chen, Sewickley, PA (US); Chen Xu, Wexford, PA (US)

(21) Appl. No.: 17/220,003

(22) Filed: Apr. 1, 2021

(51) Int. Cl. C08L 75/08; C08L 75/06

(52) U.S. Cl. CPC C08L 75/08; C08L 75/06; C08L 2205/02; C08L 2203/18; F16L 11/04

(57) ABSTRACT

The present disclosure is directed to thermoplastic polymer blends. The blends can include a first thermoplastic polyurethane and a second thermoplastic polyurethane, wherein the blend includes from 10 wt % to 50 wt % of the second thermoplastic polyurethane based on a total weight of the thermoplastic polymer blend. The first thermoplastic polyurethane can include a reaction product of a first reaction mixture consisting of or consisting essentially of an aliphatic diisocyanate and an aliphatic isocyanate-reactive component. The second thermoplastic polyurethane can include a reaction product of a second reaction mixture including a polyisocyanate, an isocyanate-reactive component having a number average molecular weight of from 500 g/mol to 10,000 g/mol, and a chain extender having a number average molecular weight of from 60 g/mol to 450 g/mol.

### BACKGROUND

Polyamide 11 (PA11) and polyamide 12 (PA12) have a variety of desirable performance benefits, such as low water uptake, high heat and chemical resistance, high flexibility, etc. Thus, these polyamides have found many applications in industry, including 3D-printing, piping for oil and gas applications, etc. As one specific example, PA11 and PA12 have been used in pressure and external sheath layers of offshore flexible pipes. Flexible piping is designed to be easy to install and can provide excellent thermal insulation, corrosion resistance, gas barrier, etc. While PA11 and PA12 can be formulated to enhance toughness and flexibility, they are not always ideal with respect to solvent resistance. Thus, there exists a need in the art for a novel material with good flexibility and corrosion resistance that also provides good solvent (e.g. methanol) resistance properties.

### BRIEF DESCRIPTION OF THE DRAWINGS

Invention features and advantages will be apparent from the detailed description which follows, taken in conjunction with the accompanying drawing, which together illustrate, by way of example, various invention embodiments; and, wherein:

FIG. 1 depicts an example of flexible piping for offshore gas or oil production.

Reference will now be made to the exemplary embodiments illustrated, and specific language will be used herein to describe the same. It will nevertheless be understood that no limitation of the scope or to specific invention embodiments is thereby intended.

### DESCRIPTION OF EMBODIMENTS

Although the following detailed description contains many specifics for the purpose of illustration, a person of ordinary skill in the art will appreciate that many variations and alterations to the following details can be made and are considered to be included herein. Accordingly, the following embodiments are set forth without any loss of generality to, and without imposing limitations upon, any claims set forth. It is also to be understood that the terminology used herein is for the purpose of describing particular embodiments only, and is not intended to be limiting. Unless defined otherwise, all technical and scientific terms used herein have the same meaning as commonly understood by one of ordinary skill in the art to which this disclosure belongs.

As used in this written description, the singular forms “a,” “an” and “the” include express support for plural referents unless the context clearly dictates otherwise. Thus, for example, reference to “a polymer” or “the polymer” can include a plurality of such polymers.

In this application, “comprises,” “comprising,” “containing” and “having” and the like can have the meaning ascribed to them in U.S. Patent law and can mean “includes,” “including,” and the like, and are generally interpreted to be open ended terms. The terms “consisting of” or “consists of” are closed terms, and include only the components, structures, steps, or the like specifically listed in conjunction with such terms, as well as that which is in accordance with U.S. Patent law. “Consisting essentially of” or “consists essentially of” have the meaning generally ascribed to them by U.S. Patent law. In particular, such terms are generally closed terms, with the exception of allowing inclusion of additional items, materials, components, steps, or elements, that do not materially affect the basic and novel characteristics or function of the item(s) used in connection therewith. For example, trace elements present in a composition, but not affecting the compositions nature or characteristics would be permissible if present under the “consisting essentially of” language, even though not expressly recited in a list of items following such terminology. When using an open ended term, like “comprising” or “including,” in this written description it is understood that direct support should be afforded also to “consisting essentially of” language as well as “consisting of” language as if stated explicitly and vice versa.

The terms “first,” “second,” “third,” “fourth,” and the like in the description and in the claims, if any, are used for distinguishing between similar elements and not necessarily for describing a particular sequential or chronological order. It is to be understood that any terms so used are interchangeable under appropriate circumstances such that the embodiments described herein are, for example, capable of operation in sequences other than those illustrated or otherwise described herein. Similarly, if a method is described herein as comprising a series of steps, the order of such steps as presented herein is not necessarily the only order in which such steps may be performed, and certain of the stated steps may possibly be omitted and/or certain other steps not described herein may possibly be added to the method.

As used herein, the term “substantially” refers to the complete or nearly complete extent or degree of an action, characteristic, property, state, structure, item, or result. For example, an object that is “substantially” enclosed would mean that the object is either completely enclosed or nearly completely enclosed. The exact allowable degree of deviation from absolute completeness may in some cases depend on the specific context. However, generally speaking the nearness of completion will be so as to have the same overall result as if absolute and total completion were obtained. The use of “substantially” is equally applicable when used in a negative connotation to refer to the complete or near complete lack of an action, characteristic, property, state, structure, item, or result. For example, a composition that is “substantially free of” particles would either completely lack particles, or so nearly completely lack particles that the effect would be the same as if it completely lacked particles. In other words, a composition that is “substantially free of” an ingredient or element may still actually contain such item as long as there is no measurable effect thereof.

As used herein, the term “about” is used to provide flexibility to a numerical range endpoint by providing that a given value may be “a little above” or “a little below” the endpoint. Unless otherwise stated, use of the term “about” in accordance with a specific number or numerical range should also be understood to provide support for such numerical terms or range without the term “about”. For example, for the sake of convenience and brevity, a numerical range of “about 50 milligrams to about 80 milligrams” should also be understood to provide support for the range of “50 milligrams to 80 milligrams.” Furthermore, it is to be understood that in this specification support for actual numerical values is provided even when the term “about” is used therewith. For example, the recitation of “about” 30 should be construed as not only providing support for values a little above and a little below 30, but also for the actual numerical value of 30 as well. Unless otherwise specified, all numerical parameters are to be understood as being prefaced and modified in all instances by the term “about,” in which the numerical parameters possess the inherent variability characteristic of the underlying measurement techniques used to determine the numerical value of the parameter.

As used herein, a plurality of items, structural elements, compositional elements, and/or materials may be presented in a common list for convenience. However, these lists should be construed as though each member of the list is individually identified as a separate and unique member. Thus, no individual member of such list should be construed as a de facto equivalent of any other member of the same list solely based on their presentation in a common group without indications to the contrary.

Concentrations, amounts, and other numerical data may be expressed or presented herein in a range format. It is to be understood that such a range format is used merely for convenience and brevity and thus should be interpreted flexibly to include not only the numerical values explicitly recited as the limits of the range, but also to include all the individual numerical values or sub-ranges encompassed within that range as if each numerical value and sub-range is explicitly recited. As an illustration, a numerical range of “1 to 5” should be interpreted to include not only the explicitly recited values of 1 to 5, but also include individual values and sub-ranges within the indicated range. Thus, included in this numerical range are individual values such as 2, 3, and 4 and sub-ranges such as from 1-3, from 2-4, and from 3-5, etc., as well as 1, 2, 3, 4, and 5, individually.

This same principle applies to ranges reciting only one numerical value as a minimum or a maximum. Furthermore, such an interpretation should apply regardless of the breadth of the range or the characteristics being described.

Reference throughout this specification to “an example” means that a particular feature, structure, or characteristic described in connection with the example is included in at least one embodiment. Thus, appearances of the phrases “in an example” in various places throughout this specification are not necessarily all referring to the same embodiment.

### Example Embodiments

The present disclosure is directed to thermoplastic polymer blends that can be employed as a substitute for PA11 and PA12 in many applications. The thermoplastic polymer blends described herein are based on semicrystalline aliphatic thermoplastic polyurethane (ATP), which includes a reaction product of a reaction mixture consisting of or consisting essentially of an aliphatic diisocyanate and a short-chain aliphatic isocyanate-reactive compound. With this in mind, ATP can have superior solvent resistance and heat resistance as compared to PA11 and PA12. Further, ATP can be blended with a variety of thermoplastic polyurethanes (TPUs) to provide a thermoplastic polymer blend having one or more improved physical properties (e.g., flexibility, for example) as compared to ATP alone. Without wishing to be bound by theory, it is believed that ATP is at least partially miscible with most TPU resins so as to form a microphase separated structure. Because of the similarity of the ATP and the hard segments in the TPU, no macrophase separation is expected in these blends. Typically, the continuous phase (matrix) can be predominantly ATP and the dispersed phase can be primarily TPU. In such blends, controlled phase separation of hard phase and soft phase can be achieved. These ATP/TPU blends can maintain the thermal properties (e.g. melting temperature) of ATP, thus maintaining its attractive physical and thermal properties and solvent resistance. Meanwhile, the soft TPU phase can tailor the physical properties of the matrix, such as, for example, tensile elongation.

In further detail, the thermoplastic polymer blend described herein can be based on a first thermoplastic polyurethane, which will be referred to herein as an ATP. The first thermoplastic polyurethane, or ATP, can generally be or include a reaction product of a first reaction mixture consisting of or consisting essentially of an aliphatic diisocyanate having a number average molecular weight of from 140 g/mol to 170 g/mol and an aliphatic isocyanate-reactive component having a number average molecular weight of from 62 g/mol to 120 g/mol. Unless otherwise specified, all molecular weights disclosed herein are to be interpreted as number average molecular weights. It is noted that the ATP is generally produced from low molecular weight constituents that are typically used to produce the hard segment of a thermoplastic polyurethane. Further, the ATP can typically be produced from low molecular weight constituents having a number average molecular weight of less than or equal to 170 g/mol. Thus, the ATP is not produced from components typically employed as soft-segment components of thermoplastic polyurethane, such as those described below with respect to the isocyanate-reactive components. Further, the use of such soft-segment components would adversely and materially affect the intended physical/thermal properties of the ATP disclosed herein. The number average molecular weights can be determined by gel permeation chromatography against a polymethyl methacrylate standard or by any other suitable method.

Suitable aliphatic diisocyanates for use in preparing the ATP can generally be monomeric aliphatic diisocyanates. Additionally, the diisocyanates employed to prepare the ATP can be produced via any suitable process, such as by phosgenation or by a phosgene-free process. Non-limiting examples of suitable aliphatic diisocyanates can be or include 1,4-diisocyanatobutane, 1,5-diisocyanatopentane, 1,6-diisocyantohexane, 1,5-diisocyanato-2-methylpentane, the like, or a combination thereof. In some specific examples, the aliphatic diisocyanate can be or include 1,4-diisocyanatobutane. In some other specific examples, the aliphatic diisocyanate can be or include 1,5-diisocyanatopentane. In additional specific examples, the aliphatic diisocyanate can be or include 1,6-diisocyantohexane. In still additional specific examples, the aliphatic diisocyanate can be or include 1,5-diisocyanato-2-methylpentane. It is further noted that the aliphatic diisocyanate used to prepare the ATP typically does not include a cycloaliphatic diisocyanate. Thus, in some examples, the monomeric aliphatic diisocyanate used to prepare the ATP includes only linear aliphatic diisocyanates, such as 1,4-diisocyanatobutane, 1,5-diisocyanatopentane, 1,6-diisocyantohexane, 1,5-diisocyanato-2-methylpentane, or the like.

A variety of suitable aliphatic isocyanate-reactive components can be combined and allowed to react with the aliphatic diisocyanate to produce the ATP. As previously described, the aliphatic isocyanate-reactive component generally has a number average molecular weight of from 62 g/mol to 120 g/mol. In some examples, the aliphatic isocyanate-reactive component can be or include an aliphatic diol. Additional minor components having a number average molecular weight of from 62 g/mol to 120 g/mol may also be included with the aliphatic diol in an amount of less than or equal to 50 wt %, less than or equal to 30 wt %, less than or equal to 10 wt %, or less than or equal to 5 wt % based on a total weight of the aliphatic isocyanate-reactive component. The additional minor components can include cycloaliphatic diols, aliphatic/cycloaliphatic diamines including at least one secondary amine, aliphatic/cycloaliphatic dithiols, the like, or a combination thereof.

As described previously, the aliphatic isocyanate-reactive component can be or include an aliphatic diol. In some specific examples, the aliphatic diol can be or include 1,2-ethanediol, 1,2-propanediol, 1,3-propanediol, 1,2-butanediol, 1,3-butandiol, 1,4-butanediol, 1,2-pentanediol, 1,3-pentanediol, 1,4-pentanediol, 1,5-pentanediol, 1,2-hexanediol, 1,3-hexanediol, 1,4-hexanediol, 1,5-hexanediol, 1,6-hexanediol, the like, or a combination thereof. In some specific examples, the aliphatic diol can be or include 1,2-ethanediol. In some other examples, the aliphatic diol can be or include 1,2-propanediol. In other examples, the aliphatic diol can be or include 1,3-propanediol. In additional examples, the aliphatic diol can be or include 1,2-butanediol. In still additional examples, the aliphatic diol can be or include 1,3-butanediol. In yet additional examples, the aliphatic diol can be or include 1,4-butanediol. In further examples, the aliphatic diol can be or include 1,2-pentanediol. In still further examples, the aliphatic diol can be or include 1,3-pentanediol. In yet further examples, the aliphatic diol can be or include 1,4-pentanediol. In additional examples, the aliphatic diol can be or include 1,5-pentanediol. In other examples, the aliphatic diol can be or include 1,2-hexanediol. In still other examples, the aliphatic diol can be or include 1,3-hexanediol. In additional examples, the aliphatic diol can be or include 1,4-hexanediol. In still additional examples, the aliphatic diol can be or include 1,5-hexanediol. In further examples, the aliphatic diol can be or include 1,6-hexanediol. It is further noted that the aliphatic diol used to prepare the ATP typically does not include a cycloaliphatic diol. Thus, in some examples, the aliphatic diol includes only linear aliphatic diols, such as 1,2-ethanediol, 1,2-propanediol, 1,3-propanediol, 1,2-butanediol, 1,3-butandiol, 1,4-butanediol, 1,2-pentanediol, 1,3-pentanediol, 1,4-pentanediol, 1,5-pentanediol, 1,2-hexanediol, 1,3-hexanediol, 1,4-hexanediol, 1,5-hexanediol, 1,6-hexanediol, or the like.

The aliphatic diisocyanate and the aliphatic isocyanate-reactive component can be combined at a variety of ratios and allowed to react to form the ATP. Generally, the aliphatic diisocyanate and the aliphatic isocyanate-reactive component can be combined at an equivalent ratio of isocyanate equivalents to isocyanate-reactive equivalents of from 0.95:1 to 1:0.95. In some additional examples, the aliphatic diisocyanate and the aliphatic isocyanate-reactive component can be combined at an equivalent ratio of isocyanate equivalents to isocyanate-reactive equivalents of from 0.98:1 to 1:0.98, or from 0.99:1 to 1:0.99.

In some additional examples, the ATP can have a z-average molecular weight (M_{z}) of from 100,000 g/mol to 900,000 g/mol. In another example, the ATP can have an M_{z} of from 100,000 g/mol to 850,000 g/mol. In still additional examples, the ATP can have an M_{z} of from 110,000 g/mol to 800,000. In yet additional examples, the ATP can have an M_{z} of from 120,000 g/mol to 760,000 g/mol. The z-average molecular weight can be determined by gel permeation chromatography against a polymethyl methacrylate standard or any other suitable method.

M_{z} can be defined by the following formula:

$${M}_{z} = \frac{{\sum }_{i} {n}_{i} {M}_{i}^{3}}{{\sum }_{i} {n}_{i} {M}_{i}^{2}} in g / mol$$

where Mᵢ is the molecular weight of a polymer chain, nᵢ is the number of polymer chains of that molecular weight, and i is the number of polymer molecules.

In some additional examples, the ATP can have a relatively low molecular weight. One way to measure the molecular weight of the ATP is via melt volume-flow rate (MVR), where higher MVR values can indicate a lower molecular weight for the neat polymer. With this in mind, in some examples, the ATP can have a melt volume-flow rate (MVR) of at least 20 cm³/10 minutes at 200° C. and 8.7 kg based on test method ASTM D1238-10. In other examples, the ATP can have an MVR of at least 30 cm³/10 minutes, or at least 35 cm³/10 minutes, or at least 40 cm³/10 minutes at 200° C. and 8.7 kg based on test method ASTM D1238-10.

Additionally, the ATP employed in the thermoplastic polymer blend can generally have a relatively high degree of crystallinity. This is because, in some examples, amorphous materials do not have good heat and solvent resistance. Thus, in some examples, the ATP can be a semicrystalline material. One way to measure the degree of crystallinity can be via melting enthalpy, where higher melting enthalpy indicates higher crystallinity. With this in mind, the ATP employed in the thermoplastic polymer blend can generally have a melting enthalpy of at least 60 joules per gram (J/g) based on differential scanning calorimetry (DSC) measurements during a second heating trace from −25° C. to 250° C. at a heating rate of 20° C./min. In some additional examples, the ATP employed in the thermoplastic polymer blend can have a melting enthalpy of at least 70 J/g, 75 J/g, 80 J/g, or 85 J/g based on DSC during a second heating trace from −25° C. to 250° C. at a heating rate of 20° C./min.

As described above the ATP can be blended with a second thermoplastic polyurethane, which will be referred to herein as a TPU, to provide a thermoplastic polymer blend having modified mechanical properties relative to ATP alone. The ATP and TPU can be blended in a variety of amounts to produce the thermoplastic polymer blend. Typically, the thermoplastic polymer blend can include from 10 wt % to 50 wt % TPU, based on a total weight of the thermoplastic polymer blend. In other examples, the thermoplastic polymer blend can include from 15 wt % to 35 wt % or from 20 wt % to 40 wt % TPU, based on a total weight of the thermoplastic polymer blend. In some specific examples, the thermoplastic polymer blend can include from 15 wt % to 25 wt %, from 20 wt % to 32 wt %, from 25 wt % to 35 wt %, or from 28 wt % to 40 wt % TPU, based on a total weight of the thermoplastic polymer blend.

A variety of TPUs can be combined with the ATP. Generally, the TPU can be a reaction product of a second reaction mixture including a polyisocyanate, an isocyanate-reactive component having a number average molecular weight (Mₙ) of from 500 g/mol to 10,000 g/mol, and a chain extender having an Mₙ of from 60 g/mol to 450 g/mol. The number average molecular weight can be determined by gel permeation chromatography against a polymethyl methacrylate standard or any other suitable method. The polyisocyanate and the chain extender can form the “hard segment” of the TPU and the isocyanate-reactive component can form the “soft segment” of the TPU.

In further detail, a variety of polyisocyanates can be employed to prepare the TPU. As used herein, the term “polyisocyanate” refers to compounds that are isocyanate-functional and include at least two un-reacted isocyanate groups. Thus, polyisocyanates can include diisocyanates and/or isocyanate-functional reaction products of diisocyanates comprising, for example, biuret, isocyanurate, uretdione, isocyanate-functional urethane, isocyanate-functional urea, isocyanate-functional iminooxadiazine dione, isocyanate-functional oxadiazine dione, isocyanate-functional carbodiimide, isocyanate-functional acyl urea, isocyanate-functional allophanate groups, the like, or combinations thereof.

The polyisocyanate employed to prepare the TPU can include an aliphatic polyisocyanate, an aromatic polyisocyanate, or a combination thereof. Non-limiting examples of aliphatic polyisocyanates can include ethylene diisocyanate, tetramethylene 1,4-diisocyanate, hexamethylene 1,6-diisocyanate, dodecane 1,12-diisocyanate, isophorone diisocyanate, cyclohexane 1,4-diisocyanate, 1-methylcyclohexane 2,4-diisocyanate, 1-methyl cyclohexane 2,6-diisocyanate, dicyclohexylmethane 4,4′-diisocyanate, dicyclohexylmethane 2,4′-diisocyanate, dicyclohexylmethane 2,2′-diisocyanate, isomers thereof, the like, or a combination thereof. Non-limiting examples of aromatic polyisocyanates can include tolylene 2,4-diisocyanate, tolylene 2,6-diisocyanate, diphenylmethane 4,4′-diisocyanate, diphenylmethane 2,4′-diisocyanate, diphenylmethane 2,2′-diisocyanate, the like, or a combination thereof.

A variety of isocyanate-reactive components can also be used to prepare the TPU. As mentioned above, the isocyanate-reactive component can generally have a number average molecular weight Mₙ of from 500 g/mol to 10,000 g/mol. In some additional examples, the isocyanate-reactive component can have an Mₙ of from 600 g/mol to 6000 g/mol, from 800 g/mol to 5000 g/mol, or from 1000 g/mol to 4000 g/mol. The number average molecular weight can be determined by gel permeation chromatography against a polymethyl methacrylate standard or any other suitable method.

Additionally, the isocyanate-reactive component can generally have an average of from 1.8 to 3.0 Zerewitinoff-active hydrogen atoms. The Zerewitinoff-active hydrogen atoms can be included in amine groups, thiol groups, carboxyl groups, hydroxyl groups, or a combination thereof. Thus, the isocyanate-reactive component can be or include a polyether, a polyester, a polycarbonate, a polycarbonate ester, a polycaprolactone, a polybutadiene, the like, or a combination thereof.

Examples of polyether polyols can be formed from the oxyalkylation of various polyols, for example, glycols such as ethylene glycol, 1,2- 1,3- or 1,4-butanediol, 1,6-hexanediol, and the like, or higher polyols, such as trimethylol propane, pentaerythritol, and the like. One commonly utilized oxyalkylation method is by reacting a polyol with an alkylene oxide, for example, ethylene oxide or propylene oxide in the presence of a basic catalyst or a coordination catalyst such as a double-metal cyanide (DMC).

Examples of suitable polyester polyols can be prepared by the polyesterification of organic polycarboxylic acids, anhydrides thereof, or esters thereof with organic polyols. Preferably, the polycarboxylic acids and polyols are aliphatic or aromatic dibasic acids and diols.

The diols which may be employed in making the polyester include alkylene glycols, such as ethylene glycol, 1,2-, 1,3-, or 1,4-butanediol, neopentyl glycol and other glycols such as cyclohexane dimethanol, caprolactone diol (for example, the reaction product of caprolactone and ethylene glycol), polyether glycols, for example, poly(oxytetramethylene) glycol and the like. However, other diols of various types and, as indicated, polyols of higher functionality may also be utilized in various embodiments of the invention. Such higher polyols can include, for example, trimethylol propane, trimethylol ethane, pentaerythritol, and the like, as well as higher molecular weight polyols such as those produced by oxyalkylating low molecular weight polyols.

The acid component of the polyester consists primarily of monomeric carboxylic acids, or anhydrides thereof, or esters thereof having 2 to 18 carbon atoms per molecule. Among the acids which are useful are phthalic acid, isophthalic acid, terephthalic acid, tetrahydrophthalic acid, hexahydrophthalic acid, adipic acid, succinic acid, azelaic acid, sebacic acid, maleic acid, glutaric acid, chlorendic acid, tetrachlorophthalic acid and other dicarboxylic acids of varying types. Also, there may be employed higher polycarboxylic acids such as trimellitic acid and tricarballylic acid.

In addition to polyester polyols formed from polybasic acids and polyols, polycaprolactone-type polyesters can also be employed. These products are formed from the reaction of a cyclic lactone such as ϵ-caprolactone with a polyol containing primary hydroxyls such as those mentioned above. Such products are described in U.S. Pat. No. 3,169,949.

Suitable hydroxy-functional polycarbonate polyols may be those prepared by reacting monomeric diols (such as 1,4-butanediol, 1,6-hexanediol, di-, tri- or tetraethylene glycol, di-, tri- or tetrapropylene glycol, 3-methyl-1,5-pentanediol, 4,4′-dimethylolcyclohexane and mixtures thereof) with diaryl carbonates (such as diphenyl carbonate, dialkyl carbonates (such as dimethyl carbonate and diethyl carbonate), alkylene carbonates (such as ethylene carbonate or propylene carbonate), or phosgene. Optionally, a minor amount of higher functional, monomeric polyols, such as trimethylolpropane, glycerol or pentaerythritol, may be used.

A variety of chain extenders can also be used to prepare the TPU. As described above, the chain extender can generally have an Mₙ of from 60 g/mol to 450 g/mol. In some additional examples, the chain extender can have an Mₙ of from 80 g/mol to 400 g/mol or from 100 g/mol to 350 g/mol. The number average molecular weight can be determined by gel permeation chromatography against a polymethyl methacrylate standard or other suitable method.

Additionally, the chain extender can generally have an average of from 1.8 to 3.0 Zerewitinoff-active hydrogen atoms. The Zerewitinoff-active hydrogen atoms can be included in amine groups, thiol groups, carboxyl groups, hydroxyl groups, the like, or a combination thereof. Thus, the chain extender can include a polyol, a polyamine, the like, or a combination thereof.

In some examples, the chain extender can include a diol. In some specific examples, the chain extender can include an aliphatic diol having from 2 to 14 carbon atoms, e.g. ethanediol, 1,2-propanediol, 1,3-propanediol, 1,4-butanediol, 2,3-butanediol, 1,5-pentanediol, 1,6-hexanediol, diethylene glycol, dipropylene glycol, the like, or a combination thereof. Additional examples of chain extenders can include a diester of terephthalic acid with a glycol having from 2 to 4 carbon atoms (e.g. bis(ethylene glycol) terephthalate or bis-1,4-butanediol terephthalate, for example), a hydroxyalkylene ether of hydroquinone (e.g. 1,4-di(b-hydroxyethyl)hydroquinone, for example), an ethoxylated bisphenol (e.g. 1,4-di(b-hydroxyethyl)bisphenol A, for example), a (cyclo)aliphatic diamine (e.g. isophoronediamine, for example), ethylenediamine, 1,2-propylenediamine, 1,3-propylenediamine, N-methylpropylene- 1,3-diamine, N,N′-dimethylethylenediamine, an aromatic diamine (e.g. 2,4-toluenediamine, 2,6-toluenediamine, 3,5-diethyl-2,4-toluenediamine or 3,5-diethyl-2,6-toluenediamine, for example) a primary monoalkyl-, dialkyl-, trialkyl- or tetraalkyl-substituted 4,4′-diaminodiphenylmethane, the like, or a combination thereof. In some specific examples, the chain extender can include ethanediol, 1,4-butanediol, 1,6-hexanediol, 1,4-di(B-hydroxyethyl)hydroquinone, 1,4-di(B-hydroxyethyl) -bisphenol A, or a combination thereof. In some further examples, the chain extender can also include a triol. It is also possible to use mixtures of any of the abovementioned chain extenders.

In some examples, compounds that are monofuntional toward isocyanates can be used as chain termination agents in an amount of up to 2 wt %, based on a total weight of the TPU. Non-limiting examples of chain termination agents can include monoamines (e.g., butylamine, dibutylamine, octylamine, stearylamine, N-methylstearylamine, pyrrolidine, piperidine, cyclohexylamine, for example) monoalcohols (e.g., butanol, 2-ethylhexanol, octanol, dodecanol, stearyl alcohol, the various amyl alcohols, cyclohexanol, ethylene glycol monomethyl ether, for example), the like, or a combination thereof.

It is noted that both the isocyanate-reactive component and the chain extender include functional groups that are reactive toward isocyanate functional groups. With this in mind, the polyisocyanate can generally be combined with the isocyanate-reactive component and the chain extender to achieve an equivalent ratio of isocyanate equivalents to equivalents of functional groups reactive toward isocyanates of from 0.9:1 to 1.2:1, or from 0.95:1 to 1.1:1.

The TPU can have a variety of Shore D hardnesses depending on the particular mechanical properties desired to be imparted to the thermoplastic polyurethane blend. Additionally, where the hard segment of the TPU has a similar composition to the ATP, it can favor good miscibility with the ATP. In some examples, the TPU can have a Shore D hardness of from 50D to 90D according to ASTM D2240-15e1. In some specific examples, the TPU can have a Shore D hardness of from 50D to 60D, from 60D to 70D, from 70D to 80D, from 75D to 85D, or from 80D to 90D according to ASTM D2240-15e1.

The ATP and the TPU can be mixed in a variety of ways, such as via co-extrusion, batch mixing, or the like. Additionally, the ATP and the TPU can be mixed at any suitable temperature to allow both components to thoroughly mix and interact.

As described above, the thermoplastic polymer blends described herein can provide a material having a variety of desirable thermal, mechanical, and chemical properties. For example, in some cases, the thermoplastic polymer blends described herein can have an elongation at break that is greater than an elongation at break of the ATP alone. In some additional examples, the thermoplastic polymer blends can have an elongation at break of at least 140% based on ASTM D638-14 at 23° C. In still additional examples, the thermoplastic polymer blends can have an elongation at break of at least 180%, at least 230%, or at least 270% based on ASTM D638-14 at 23° C.

In some additional examples, the thermoplastic polymer blends can have a tensile modulus that is less than a tensile modulus of the ATP alone. For example, in some cases, the thermoplastic polymer blends can have a tensile modulus of less than 1800 megapascals (MPa) based on ASTM D638-14 at 23° C. In some additional examples, the thermoplastic polymer blends can have a tensile modulus of less than 1500 MPa, less than 1400 MPa, or less than 1300 MPa based on ASTM D638-14 at 23° C. In some specific examples, the thermoplastic polymer blends can have a tensile modulus of from 1200 MPa to 1400 MPa, from 1400 MPa to 1600 MPa, or from 1600 MPa to 1800 MPa based on ASTM D638-14 at 23° C.

In some cases, the thermoplastic polymer blends can have comparable or slightly decreased tensile strength as compared to ATP alone, but can still have a tensile strength that is comparable to or better than PA11, for example. With this in mind, in some cases, the thermoplastic polymer blends described herein can have a tensile strength at yield of at least 35 MPa based on ASTM D638-14 at 23° C. In still additional examples, the thermoplastic polymer blends can have a tensile strength at yield of at least 40 MPa, at least 45 MPa, at least 50 MPa, or at least 55 MPa based on ASTM D638-14 at 23° C. In some specific examples, the thermoplastic polymer blends can have a tensile strength at yield of from 35 MPa to 45 MPa, from 40 MPa to 50 MPa, from 45 MPa to 55 MPa, or from 50 MPa to 60 MPa based on ASTM D638-14 at 23° C.

In some further examples, the thermoplastic polymer blends can have a tensile strength at break of at least 35 MPa based on ASTM D638-14 at 23° C. In still additional examples, the thermoplastic polymer blends can have a tensile strength at break of at least 40 MPa, at least 45 MPa, at least 50 MPa, or at least 55 MPa based on ASTM D638-14 at 23° C. In some specific examples, the thermoplastic polymer blends can have a tensile strength at break of from 35 MPa to 45 MPa, from 40 MPa to 50 MPa, from 45 MPa to 55 MPa, or from 50 MPa to 60 MPa based on ASTM D638-14 at 23° C.

The thermoplastic polymer blends can be tailored for a variety of applications, such as oil and gas, aerospace, automotive, textile, electronics, sports equipment, tubing, wire sheathing, metal coating, and other desirable applications. With this in mind, a few non-limiting examples of specific applications for the thermoplastic polymer blends described herein can include coatings, molded parts, extruded parts, additive manufacturing, or the like.

One specific example of an application where the present thermoplastic polymer blends can be employed is in piping or conduits for offshore oil or gas production sites. Examples of piping used in offshore oil or gas production sites can include transfer lines to link floating components, umbilicals (e.g., for electrical cables, fiber optics, hydraulic fluid cables, etc.), risers to bring subsea production up to the platform, flowlines for gathering or exporting subsea production fluids, jumpers for connecting wells to manifolds or other structures, etc.

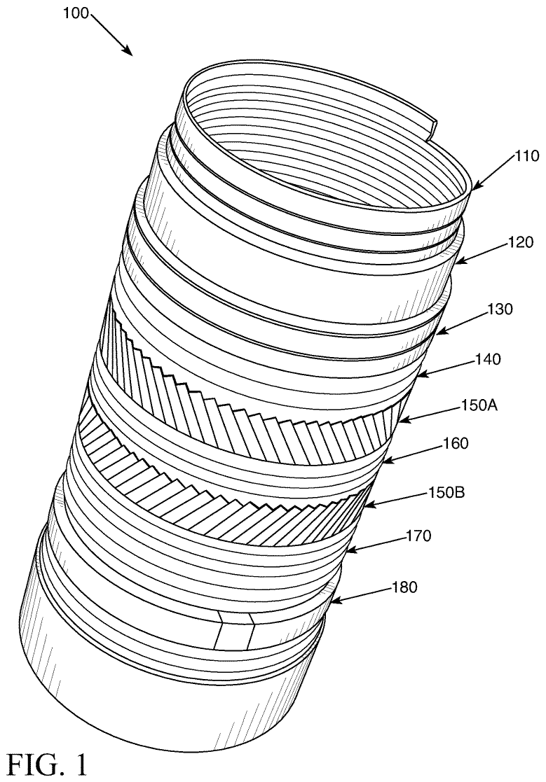

One specific example of a flexible pipe 100 for use in offshore oil or gas production sites is illustrated in FIG. 1. Flexible pipe 100 includes various layers to provide a variety of functions for the flexible pipe. A carcass layer 110 is generally made of stainless steel or other strong material to prevent collapse of the pipe under external pressure.

A pressure sheath layer 120 is disposed on the carcass layer 110 and can act as a fluid sealing layer. The pressure sheath layer 120 can typically have a thickness of from 5 mm to 13 mm and can include a thermoplastic material, such as high density polyethylene (HDPE), cross-linked polyethylene (XLPE), PA11, PA12, polyvinylidene difluoride (PVDF), a thermoplastic polymer blend as described herein, or the like.

An interlocked pressure armor layer 130 can be disposed on the pressure sheath layer 120. The layer 130 can serve to resist both internal and external pressure. Typically, layer 130 can be made of carbon steel or other suitably strong material.

An anti-wear layer 140 can be disposed on the interlocked pressure armor layer 130. The anti-wear layer can typically be made of polyamide 6 (PA6) or PA11 tapes having a thickness of from 1-3 mm. This type of layer is generally used more frequently in dynamic risers than in static applications.

Layers 150A and 150B can be tensile armor layers. These layers can include contra-wound carbon steel wires, or the like to provide axial strength to the flexible pipe 100.

Intermediate sheath layer 160 can be disposed between the tensile armor layers 150A, 150B. In some other examples, the intermediate sheath layer 160 can be disposed between the interlocked pressure armor 130 and the tensile strength layer 150A in place of the anti-wear layer 140. The intermediate sheath layer can generally be made of or include a thermoplastic material, such as HDPE, XLPE, PA11, PA12, PVDF, a thermoplastic polymer blend as described herein, or the like. The layer 160 can act as a fluid barrier, to minimize wear between adjacent layers, etc.

Insulating layer 170 can be disposed on tensile armor layer 150B and can be used to reduce heat loss. This layer can be made from or include a variety of thermally insulating materials.

Thermoplastic outer sheath layer 180 can be disposed on insulating layer 170. Layer 180 can act as a marine barrier. Depending on the application for the flexible pipe 100, this layer may be formed of different materials. For example, in some cases, where the flexible pipe 100 is intended for use in static applications (e.g., a flowline), the layer 180 may be formed of or include medium density polyethylene (MDPE), HDPE, a thermoplastic polymer blend as described herein, or the like. In some other examples, where flexible pipe 100 is intended for use in dynamic applications, layer 180 may be formed of or include PA11, a thermoplastic polymer blend as described herein, or the like.

With this in mind, the present disclosure also describes a flexible pipe having at least one layer formed of or including a thermoplastic polymer blend as described herein. In some examples, the layer including the thermoplastic polymer blend can be or include a thermoplastic outer sheath layer. In some additional examples, the layer including the thermoplastic polymer blend can be or include an intermediate sheath layer. In some further examples, the layer including the thermoplastic polymer blend can be or include a pressure sheath layer. In some additional examples, a combination of at least two of a thermoplastic outer sheath layer, an intermediate sheath layer, and a pressure sheath layer can be formed of or include the thermoplastic polymer blend. In still additional examples, each of a thermoplastic outer sheath layer, an intermediate sheath layer, and a pressure sheath layer can be formed of or include the thermoplastic polymer blend.

The present disclosure also describes a method of making a thermoplastic polymer blend. The method can include blending a first thermoplastic polyurethane (an ATP) with a second thermoplastic polyurethane (a TPU) to prepare the thermoplastic polymer blend. The ATP can include of a reaction product of a reaction mixture consisting of or consisting essentially of an aliphatic diisocyanate having a molecular weight of from 140 g/mol to 170 g/mol and an aliphatic isocyanate-reactive component having a molecular weight of from 62 g/mol to 120 g/mol. The second thermoplastic polyurethane (or TPU) can include a reaction product of a reaction mixture including a polyisocyanate, an isocyanate-reactive component having a number average molecular weight of from 500 g/mol to 10,000 g/mol, and a chain extender having a number average molecular weight of from 60 g/mol to 450 g/mol. The thermoplastic polymer blend can typically include from 10 wt % to 50 wt % thermoplastic polyurethane, based on a total weight of the thermoplastic polymer blend.

In some examples, the aliphatic diisocyanate and the aliphatic isocyanate-reactive component can be combined at an equivalent ratio of isocyanate equivalents to isocyanate-reactive equivalents of from 0.95:1 to 1:0.95, or at another suitable equivalent ratio as described herein. In some additional examples, the polyisocyanate can be combined with the isocyanate-reactive component and the chain extender at an equivalent ratio of isocyanate equivalents to equivalents of functional groups reactive toward isocyanate groups of from 0.9:1 to 1.2:1.

### EXAMPLES

### Example I—Physical Property Testing of Thermoplastic Polymer Blends

A first thermoplastic polyurethane, or an aliphatic thermoplastic polyurethane (ATP), as described herein having a melt volume-flow rate (MVR) of 40 cm³/10 minutes at 200° C. and 8.7 kg was blended with various second thermoplastic polyurethanes, or TPUs, by hand at room temperature to prepare various thermoplastic polymer blends. The thermoplastic polymer blends were then molded for tensile testing using an Milacron Roboshot injection molding machine at a temperature of 410-420° F. Tensile tests were conducted according to ASTM D638-14 at 23° C. DSC analyses were preformed using a Perkin Elmer DSC8000 heating from −25° C. to 250° C. with a cooling and heating rate of 20° C./min. Data points were collected on the second heating trace. The test results are listed in Tables I-IV below:

TABLE I
Thermoplastic Polymer Blends using TPU1

| | | | | | Tensile | Tensile |
|---|---|---|---|---|---|---|
| | | Melting | Elongation | Tensile | strength | strength |
| | T_{ₘ} | enthalpy | at break | modulus | at yield | at break |
| Sample | (° C.) | ΔH (J/g) | (%) | (MPa) | (MPa) | (MPa) |
| PA11^{a} | 186 | 55 | 80.5 | 1236 | 39.1 | 41 |
| (Comparative) | | | | | | |
| Plasticized | 181 | 46 | 149.9 | 283 | 36.5 | 36.1 |
| PA11^{b} | | | | | | |
| (Comparative) | | | | | | |
| PA11 + 30% | 141 | 1.6 | 105.5 | 1460 | 49.1 | 48.3 |
| TPU1^{c} | | | | | | |
| (Comparative) | | | | | | |
| ATP | 179 | 85 | 11.7 | 1816 | 58.3 | 55.7 |
| (Comparative) | | | | | | |
| ATP + 10% | 179 | 82 | 21.0 | 1782 | 55.4 | 50.7 |
| TPU1 | | | | | | |
| (Inventive) | | | | | | |
| ATP + 30% | 162 | 43 | 43.4 | 1766 | 58.4 | 46.6 |
| TPU1 | | | | | | |
| (Inventive) | | | | | | |
| ATP + 50% | 153 | 13.5 | 36.3 | 1460 | 48.3 | 49.1 |
| TPU1 | (broad) | | | | | |
| (Inventive) | | | | | | |

^{a}RILSAN ® BESNO TL PA11 from ARKEMA
^{b}RILSAN ® BESNO TL PA11 from ARKEMA
^{c}Aliphatic TPU based on polyester polyol and having a Shore D hardness of 80D obtained from COVESTRO ®

TABLE II
Thermoplastic Polymer Blends using TPU2

| | | | | | Tensile | Tensile |
|---|---|---|---|---|---|---|
| | | Melting | Elongation | Tensile | strength | strength |
| | Tₘ | enthalpy | at break | modulus | at yield | at break |
| Sample | (° C.) | ΔH (J/g) | (%) | (MPa) | (MPa) | (MPa) |
| PA11^{a} | 186 | 55 | 80.5 | 1236 | 39.1 | 41 |
| (Comparative) | | | | | | |
| Plasticized | 181 | 46 | 149.9 | 283 | 36.5 | 36.1 |
| PA11^{b} | | | | | | |
| (Comparative) | | | | | | |
| ATP | 179 | 85 | 11.7 | 1816 | 58.3 | 55.7 |
| (Comparative) | | | | | | |
| ATP + 30% | 176 | 56 | 141.2 | 1277 | 41.5 | 41.3 |
| TPU2^{d} | | | | | | |
| (Inventive) | | | | | | |

^{a}RILSAN ® BESNO TL PA11 from ARKEMA
^{b}RILSAN ® BESNO TL PA11 from ARKEMA
c. Aliphatic TPU based on polyester polyol and having a Shore D hardness of 80D obtained from COVESTRO ®
^{d}Aromatic TPU based on polyether polyol and having a Shore D hardness of 50D obtained from COVESTRO ®

TABLE III
Thermoplastic Polymer Blends using TPU3

| | | | | | Tensile | Tensile |
|---|---|---|---|---|---|---|
| | | Melting | Elongation | Tensile | strength | strength |
| | Tₘ | enthalpy | at break | modulus | at yield | at break |
| Sample | (° C.) | ΔH (J/g) | (%) | (MPa) | (MPa) | (MPa) |
| PA11^{a} | 186 | 55 | 80.5 | 1236 | 39.1 | 41 |
| (Comparative) | | | | | | |
| Plasticized | 181 | 46 | 149.9 | 283 | 36.5 | 36.1 |
| PA11^{b} | | | | | | |
| (Comparative) | | | | | | |
| ATP | 179 | 85 | 11.7 | 1816 | 58.3 | 55.7 |
| (Comparative) | | | | | | |
| ATP + 30% | 180 | 58 | 53.1 | 1248 | 39.7 | 38.6 |
| TPU3^{e} | | | | | | |
| (Inventive) | | | | | | |

^{a}RILSAN ® BESNO TL PA11 from ARKEMA
^{b}RILSAN ® BESNO TL PA11 from ARKEMA
c. Aliphatic TPU based on polyester polyol and having a Shore D hardness of 80D obtained from COVESTRO ®
d. Aromatic TPU based on polyether polyol and having a Shore D hardness of 50D obtained from COVESTRO ®
^{e}Aliphatic TPU based on polyether polyol and having a Shore D hardness of 55D obtained from COVESTRO ®

TABLE IV
Thermoplastic Polymer Blends using TPU4

| | | | | | Tensile | Tensile |
|---|---|---|---|---|---|---|
| | | Melting | Elongation | Tensile | strength | strength |
| | Tₘ | enthalpy | at break | modulus | at yield | at break |
| Sample | (° C.) | ΔH (J/g) | (%) | (MPa) | (MPa) | (MPa) |
| PA11^{a} | 186 | 55 | 80.5 | 1236 | 39.1 | 41 |
| (Comparative) | | | | | | |
| Plasticized | 181 | 46 | 149.9 | 283 | 36.5 | 36.1 |
| PA11^{b} | | | | | | |
| (Comparative) | | | | | | |
| ATP | 179 | 85 | 11.7 | 1816 | 58.3 | 55.7 |
| (Comparative) | | | | | | |
| ATP + 30% | 169 | 42 | 278.3 | 1258 | 38.7 | 50.8 |
| TPU4^{f} | | | | | | |
| (Inventive) | | | | | | |

^{a}RILSAN ® BESNO TL PA11 from ARKEMA
^{b}RILSAN ® BESNO TL PA11 from ARKEMA
c. Aliphatic TPU based on polyester polyol and having a Shore D hardness of 80D obtained from COVESTRO ®
d. Aromatic TPU based on polyether polyol and having a Shore D hardness of 50D obtained from COVESTRO ®
e. Aliphatic TPU based on polyether polyol and having a Shore D hardness of 55D obtained from COVESTRO ®
^{f}Aromatic TPU based on polyether polyol and having a Shore D hardness of 76D obtained from COVESTRO ®

Both PA11 and plasticized PA11 were used as comparative examples. As indicated by the results in Tables I-IV, adding plasticizer to PA11 improves the elongation at break but decreases the modulus and tensile strength. ATP was also used as a comparative example to illustrate the differences between the thermoplastic polymer blends and the ATP base material. ATP has lower elongation at break as compared to PA11, which may be due to a lower molecular weight (higher MVR, based on ASTM D1238-10) than PA11 as indicated in Table V below:

TABLE V
MVR values

| | PA11 | Plasticized PA11 | ATP |
|---|---|---|---|
| MVR | 10.5 | 5.0 | 40 |
| (cm³/10 minutes | | | |
| 200° C., 8.7 kg) | | | |

In further detail with respect to the data presented in Tables I-IV above, these data illustrate that thermoplastic polymer blends including even low amounts (e.g., 10 wt %) of TPU can provide improved tensile elongation at break as compared to ATP alone. Thermoplastic polymer blends including 30% TPU demonstrate significant improvement of tensile elongation at break while maintaining comparable tensile modulus and strength as compared to ATP alone. Further, the 30% blends from Tables I and III demonstrate better mechanical properties as compared to plasticized PA11. In contrast, PA11 plasticized by TPU has significantly worse thermal properties than any of the other samples. Thus, ATP and TPU appear to be remarkably compatible to provide a thermoplastic polymer blend with surprising physical, mechanical, and thermal properties that are not present when blending TPU with polyamides, for example.

### Example II—Solvent absorption

Some of the samples prepared in Example I were used to evaluate water and methanol adsorption over time. Specifically, samples were weighed and placed in water or methanol for a period of 28 days. At seven days and at 28 days the samples were weighed again to determine how much solvent was adsorbed at each time point. The samples were then dried to determine how much mass was lost due to solvent extraction. The results are presented below in Tables VI and VII:

TABLE VI
Water Absorption

| | | Day 7 (% | Day 28 (% | Re- |
|---|---|---|---|---|
| | Day 0 | increase) | increase) | dried |
| PA11 | 8.20 g | 8.24 g (0.5%) | 8.27 g (0.85%) | 8.17 g |
| (Comparative) | | | | |
| Plasticized | 8.32 g | 8.38 g (0.7%) | 9.41 g (13.1%) | 7.95 g |
| PA11 | | | | |
| (Comparative) | | | | |
| ATP | 9.78 g | 9.84 g (0.6%) | 9.85 g (0.72%) | 9.75 g |
| (Comparative) | | | | |
| ATP + 10% | 9.76 g | 9.85 g (0.92%) | 9.87 g (1.1%) | 9.74 g |
| TPU1 | | | | |
| (Inventive) | | | | |
| ATP + 30% | 9.56 g | 9.67 g (1.2%) | 9.72 g (1.7%) | 9.57 g |
| TPU1 | | | | |
| (Inventive) | | | | |

TABLE VII
Methanol Absorption

| | | Day 7 (% | Day 28 (% | Re- |
|---|---|---|---|---|
| | Day 0 | increase) | increase) | dried |
| PA11 | 8.16 g | 8.83 g (8.2%) | 9.07 g (11.2%) | 8.10 g |
| (Comparative) | | | | |
| Plasticized | 8.32 g | 8.62 g | 8.36 g | 7.18 g |
| PA11 | | | | |
| (Comparative) | | | | |
| ATP | 9.71 g | 10.03 g (3.0%) | 10.29 g (6.0%) | 9.71 g |
| (Comparative) | | | | |
| ATP + 10% | 9.74 g | 10.08 g (3.5%) | 10.40 g (6.8%) | 9.72 g |
| TPU1 | | | | |
| (Inventive) | | | | |
| ATP + 30% | 9.58 g | 10.71 g (11.8%) | 10.96 g (14.4%) | 9.55 g |
| TPU1 | | | | |
| (Inventive) | | | | |

As can be seen in Tables VI and VII, both ATP and the thermoplastic polymer blends show very low water absorption comparable to PA11. In contrast, plasticized PA11 demonstrated significant swelling while soaking in water. In methanol, ATP and the thermoplastic polymer blends demonstrated comparable or better solvent absorption as compared to PA11. Further, in both water and methanol, significant amounts of plasticizer were extracted from the plasticized PA11, resulting in considerable loss in mass. Thus, while the thermoplastic polymer blends can demonstrate comparable physical properties to plasticized PA11, they can also provide superior solvent resistance to plasticized PA11.

It should be understood that the above-described methods are only illustrative of some embodiments of the present invention. Numerous modifications and alternative arrangements may be devised by those skilled in the art without departing from the spirit and scope of the present invention and the appended claims are intended to cover such modifications and arrangements. Thus, while the present invention has been described above with particularity and detail in connection with what is presently deemed to be the most practical and preferred embodiments of the invention, it will be apparent to those of ordinary skill in the art that variations including, may be made without departing from the principles and concepts set forth herein.

What is claimed is:

1. A thermoplastic polymer blend, comprising:
a first thermoplastic polyurethane comprising a reaction product of a first reaction mixture consisting essentially of an aliphatic diisocyanate having a number average molecular weight of from 140 g/mol to 170 g/mol and an aliphatic isocyanate-reactive component having a number average molecular weight of from 62 g/mol to 120 g/mol; and
a second thermoplastic polyurethane comprising a reaction product of a second reaction mixture comprising a polyisocyanate, an isocyanate-reactive component having a number average molecular weight of from 500 g/mol to 10,000 g/mol, and a chain extender having a number average molecular weight of from 60 g/mol to 450 g/mol,
wherein the thermoplastic polymer blend comprises from 10 wt % to 50 wt % of the second thermoplastic polyurethane, based on a total weight of the thermoplastic polymer blend.

2. The thermoplastic polymer blend of claim 1, wherein the aliphatic diisocyanate comprises 1,4-diisocyanatobutane, 1,5-diisocyanatopentane, 1,6-diisocyantohexane, 1,5-diisocyanato-2-methylpentane, or a combination thereof.

3. The thermoplastic polymer blend of claim 1, wherein the aliphatic isocyanate-reactive component comprises 1,2-ethanediol, 1,2-propanediol, 1,3-propanediol, 1,2-butanediol, 1,3-butandiol, 1,4-butanediol, 1,2-pentanediol, 1,3-pentanediol, 1,4-pentanediol, 1,5-pentanediol, 1,2-hexanediol, 1,3-hexanediol, 1,4-hexanediol, 1,5-hexanediol, 1,6-hexanediol, or a combination thereof.

4. The thermoplastic polymer blend of claim 1, wherein the first thermoplastic polyurethane has a z-average molecular weight of from 100,000 g/mol to 900,000 g/mol.

5. The thermoplastic polymer blend of claim 1, wherein the first thermoplastic polyurethane has a melt volume-flow rate of at least 20 cm³/10 minutes at 200° C. and 8.7 kg based on ASTM D1238-10.

6. The thermoplastic polymer blend of claim 1, wherein the first thermoplastic polyurethane has a melting enthalpy of at least 60 J/g based on differential scanning calorimetry during a second heating trace from −25° C. to 250° C. at a heating rate of 20° C./min.

7. The thermoplastic polymer blend of claim 1, wherein the polyisocyanate comprises an aliphatic polyisocyanate.

8. The thermoplastic polymer blend of claim 1, wherein the polyisocyanate comprises an aromatic polyisocyanate.

9. The thermoplastic polymer blend of claim 1, wherein the isocyanate-reactive component comprises a polyether polyol.

10. The thermoplastic polymer blend of claim 1, wherein the isocyanate-reactive component comprises a polyester polyol.

11. The thermoplastic polymer blend of claim 1, wherein the second thermoplastic polyurethane has a Shore D hardness of from 50D to 90D according to ASTM D2240-15e1.

12. The thermoplastic polymer blend of claim 1, wherein the thermoplastic polymer blend has an elongation at break of at least 140% based on ASTM D638-14 at 23° C.

13. The thermoplastic polymer blend of claim 1, wherein the thermoplastic polymer blend has a tensile modulus of less than 1800 MPa based on ASTM D638-14 at 23° C.

14. The thermoplastic polymer blend of claim 1, wherein the thermoplastic polymer blend has tensile strength at yield of at least 35 MPa based on ASTM D638-14 at 23° C.

15. The thermoplastic polymer blend of claim 1, wherein the thermoplastic polymer blend has a tensile strength at break of at least 35 mPa based on ASTM D638-14 at 23° C.

16. A flexible pipe, comprising:
a plurality of layers, wherein at least one layer comprises the thermoplastic polymer blend of claim 1.

17. The flexible pipe of claim 16, wherein the at least one layer comprises a thermoplastic outer sheath layer, an intermediate sheath layer, a pressure sheath layer, or a combination thereof.

18. A method of making a thermoplastic polymer blend, comprising:
blending a first thermoplastic polyurethane with a second thermoplastic polyurethane to prepare the thermoplastic polymer blend,
wherein the first thermoplastic polyurethane comprises a reaction product of a first reaction mixture consisting essentially of an aliphatic diisocyanate having a number average molecular weight of from 140 g/mol to 170 g/mol and an aliphatic isocyanate-reactive component having a number average molecular weight of from 62 g/mol to 120 g/mol,
wherein the second thermoplastic polyurethane comprises a reaction product of a second reaction mixture comprising a polyisocyanate, an isocyanate-reactive component having a number average molecular weight of from 500 g/mol to 10,000 g/mol, and a chain extender having a number average molecular weight of from 60 g/mol to 450 g/mol, and
wherein the thermoplastic polymer blend comprises from 10 wt % to 50 wt % of the second thermoplastic polyurethane, based on a total weight of the thermoplastic polymer blend.

19. The method of claim 18, wherein the aliphatic diisocyanate and the aliphatic isocyanate-reactive component are combined at an equivalent ratio of isocyanate equivalents to isocyanate-reactive equivalents of from 0.95:1 to 1:0.95.

20. The method of claim 18, wherein the polyisocyanate is combined with the isocyanate-reactive component and the chain extender at an equivalent ratio of isocyanate equivalents to equivalents of functional groups reactive toward isocyanate groups of from 0.9:1 to 1.2:1.
